(19) United States
(12) Patent Application Publication
(10) Pub. No.: US 2011/0253729 A1
(43) Pub. Date: Oct. 20, 2011

(54) CONTAINER FOR DISPENSING FLUID

(76) Inventors: Thomas J. Ring, Palos Heights, IL (US); John S. Letchinger, Wilmette, IL (US); Daniel L. O'Malley, Wilmette, IL (US); Kenneth W. Reick, Glen Ellyn, IL (US); Linc E. Cholke, Vernon Hills, IL (US); Kevin J. Cox, Northbrook, IL (US)

(21) Appl. No.: 13/045,023

(22) Filed: Mar. 10, 2011

Related U.S. Application Data
(60) Provisional application No. 61/312,761, filed on Mar. 11, 2010.

(51) Int. Cl. B65D 8/04; B65D 41/04; B23P 11/00; B65D 1/04

(52) U.S. Cl. 220/681; 215/6; 220/682; 220/288; 29/428

(57) ABSTRACT

A fluid dispensing device which includes a reservoir formed by a sidewall and a bottom wherein the sidewall defines an opening to the reservoir opposing the bottom wherein the opening is one of equal or greater dimension than the bottom. The device also includes an enclosure positioned within the reservoir wherein the enclosure defines a space separate from an interior of the reservoir wherein the space is in communication with another opening defined by one of the bottom and the sidewall for accessing the space from an exterior of the reservoir. In another embodiment, a fluid dispensing device which includes a reservoir formed by a sidewall and a bottom. The device also includes an enclosure positioned within the reservoir wherein the enclosure defines a space separate from an interior of the reservoir wherein the space is in communication with another opening defined by one of the bottom and the sidewall for accessing the space from an exterior of the reservoir and wherein the enclosure comprises opposing spaced apart wall members. Methods to assemble the same are also provided.

### RELATED APPLICATIONS

This application claims priority to U.S. Provisional Patent Application No. 61/312,761, filed Mar. 11, 2010, the entire contents of which are incorporated herein by reference.

### FIELD OF THE INVENTION

The present invention generally relates to a refillable container for holding a fluid and from which the fluid is dispensed which includes drinking the fluid from the container and, more particularly, a container which facilitates mixing of its contents.

### SUMMARY

In one example a fluid dispensing device is provided which includes a reservoir formed by a sidewall and a bottom wherein the sidewall defines an opening to the reservoir opposing the bottom wherein the opening is one of equal or greater dimension than the bottom. The device also includes an enclosure positioned within the reservoir wherein the enclosure defines a space separate from an interior of the reservoir wherein the space is in communication with another opening defined by one of the bottom and the sidewall for accessing the space from an exterior of the reservoir.

In another example a method for assembling a fluid dispensing device is provided, including the steps of providing a reservoir which includes a sidewall and a bottom wherein the sidewall defines an opening opposing the bottom wherein the opening is one of equal or greater dimension than the bottom and an enclosure positioned within the reservoir wherein the enclosure defines a space separate from an interior of the reservoir wherein the space is in communication with another opening defined by one of the bottom and the sidewall for accessing the space from an exterior of the reservoir. Also, the method includes the step of placing an insert item which carries visual information into the space defined by the enclosure.

In another example a fluid dispensing device is provided which includes a reservoir comprising a sidewall and a bottom. It also includes an enclosure positioned within the reservoir wherein the enclosure defines a space separate from an interior of the reservoir wherein the space is in communication with another opening defined by one of the bottom and the sidewall for accessing the space from an exterior of the reservoir and wherein the enclosure includes opposing spaced apart wall members.

In another example a method for assembling a fluid dispensing device is provided which includes the steps of providing a reservoir which includes a sidewall and a bottom and an enclosure positioned within the reservoir wherein the enclosure defines a space separate from an interior of the reservoir wherein the space is in communication with another opening defined by one of the bottom and he sidewall for accessing the space from an exterior of the reservoir. It also includes the step of placing an insert item which carries visual information into the space defined by the enclosure.

In another example an easy open cap for a container is provided.

In another example, a way to display visual information from within the container is provided. A wide variety of information can be portrayed including for example, written, symbolic and/or artistic types of information. Some examples may include and are not limited to, personal identification of the user of the container, such as written and/or pictorial information to which the user can identify the container as the user's; advertising and marketing information such as advertising copy, products, trademarks, logos, trade names, names of groups, events and the like; identification of contents of the container; and portrayal of literary works and/or decorative art work including pictures etc. One or more insert items may be displayed within the enclosure. Other insert items could include lights powered by batteries or solar cells or other lighting elements commonly known and used. The illumination emitted from and through the enclosure could be used to assist in viewing of other insert item(s) housed within the enclosure and/or be used by itself to illuminate the interior of the container and/or its contents.

In another example an enclosure is provided which projects through a portion of the interior of the container and which is capable of imparting a shear force on liquid contained within the bottle when the container is shaken This shear force assists in mixing a drink, for example, that contains a combination of a fluid with one or more of ice, a powder, a syrup, pieces of solid food items such as fruits vegetables and even another fluid In another example a portion of the container positioned spaced apart from and below a top opening of the container through which the user consumes the fluid contained in the container, a sidewall of the container is separable, dividing the container into a top and bottom portions. The top and bottom portions each define compatible threads for securement and release of the top and bottom portions of the container. Since the separable location of the sidewall of the container is where the container has a wider dimension than the top opening through which one drinks, the interior of the top and bottom portions of the container can thereby be easily accessed for cleaning the interior part of the container and the enclosure. With the wider opening, hand washing and dish washers are both effective in cleaning the interior of the container. This opening likewise provides ease in placing ingredients and ice into the lower portion of the bottle for hand mixing before closing the top portion onto the lower portion of the container. Otherwise, the user may close the top portion onto the bottom portion, and with the cap covering the top opening of the container, and shake the container employing the enclosure to assist in mixing the contents of the container.

### BRIEF DESCRIPTION OF THE DRAWINGS

FIG. 1 is a top perspective view of an exemplary container of the present invention;

FIG. 2 is a front plan profile view of an exemplary container of the present invention;

FIG. 3 is a side plan profile view of an exemplary container of the present invention;

FIG. 4 is a bottom plan view of an exemplary container of the present invention without a plug member positioned in the opening defined in the bottom of the container;

FIG. 5 is a top plan view of a lower portion of the exemplary container of the present invention without a top portion of the container secured to the lower portion of the container;

FIG. 6 is an exploded perspective view of an exemplary container of the present invention;

FIG. 7 is a cross section view taken along line 7-7 of FIG. 3 of an exemplary container of the present invention;

FIG. 8 is a top perspective view of the plug member of the exemplary container of the present invention;

FIG. 8A is a top perspective view of another embodiment of the plug member shown in FIG. 8;

FIG. 8B is a cross section taken along line 8B-8B in FIG. 8A;

FIG. 9 is a perspective broken away view of an exemplary container of the present invention;

FIG. 9A is an enlarged view of that which is circled as 9A in FIG. 9;

FIG. 9B is an enlarged view of that which is circled as 9B in FIG. 9;

FIG. 9C is an enlarged view of that which is circled as 9C in FIG. 9;

FIG. 10 is a broken away view of a lower portion of an exemplary container of the present invention;

FIG. 11 is a top perspective view of an exemplary cap seal of the present invention;

FIG. 12 is a top plan view of the cap seal of FIG. 11;

FIG. 13 is a cross section taken along line 13-13 of FIG. 12;

FIG. 13A is an enlarged view of that which is circled in FIG. 13;

FIG. 14 is a top perspective view of an exemplary body seal of the present invention;

FIG. 15 is a top plan view of the body seal of FIG. 14;

FIG. 16 is a cross section view taken along line 16-16 in FIG. 15; and

FIG. 16A is an enlarged view of that which is circled in FIG. 16.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

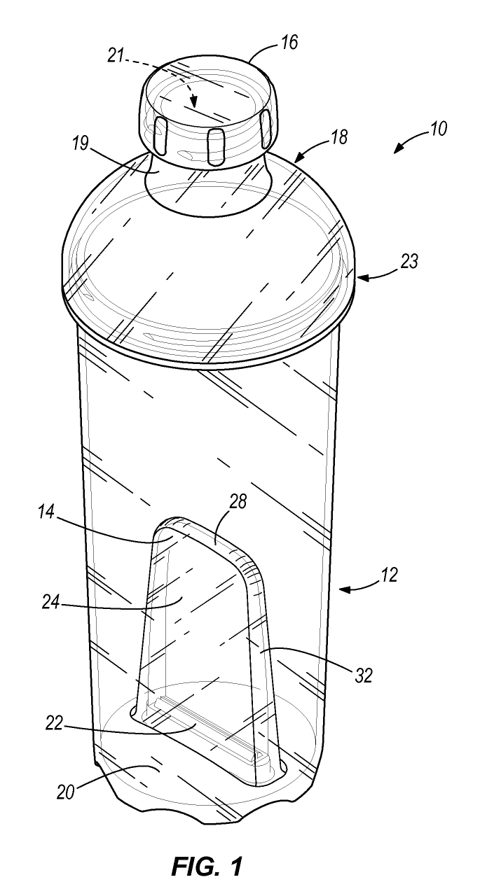

With reference to FIG. 1, is an exemplary refillable container 10 or in this instance bottle 10. This embodiment can be employed to mix various drinks, be employed to dispense the liquid contents of the container which includes drinking therefrom and/or to display visual information as desired for identification to user and/or marketing, advertising etc. In the illustrated exemplary embodiment, container 10 is constructed of a transparent plastic providing easy viewing into the interior of container 10. In other embodiments, the material used may be translucent or any combination of transparent, translucent and opaque materials. Any part or portion of bottle 10 can be made of a desired color(s). In an embodiment, lower portion or reservoir 12 of container 10 would be constructed to be transparent and/or translucent and may or may not be constructed with color. This construction also allows one to easily view the interior of container 10 and enclosure 14 which is positioned in lower portion or reservoir 12 of container 10, in this example.

Many different materials are contemplated to make all or parts and/or portions of container 10. Materials such as plastic, polycarbonates, glass, metal etc. can be used. In the illustrated embodiment a plastic known as Tritan Copolyester made by Eastman Chemical is employed by way of injection molding. This particular plastic is absent BPA's and is approved to contact food by the FDA. This material is also impact resistant, will provide insulation for hot and cold liquids and provides remarkable clarity.

Container 10 can be constructed to be flexible or somewhat stiff to the feel. In one embodiment the wall thickness can vary between 0.025 and 0.060 inches. In the embodiment illustrated, the wall thickness is 0.040 inches. Other wall thicknesses are contemplated depending on a number of variables such as durability and temperature of the fluids to be contained.

It is also contemplated that an embodiment will employ an antimicrobial material incorporated into the material used to construct container 10. An antimicrobial material such as PolySept, a registered trademark of Ply Chem Alloy, Inc. described in U.S. Pat. No. 6,284,814, can be employed and will reduce the growth of undesirable bacteria and provide the user with a more sanitary bottle 10 during particularly reuse of container 10.

Container 10 may contain or hold liquids of different temperatures. To maintain desired temperatures, container 10 will need thermal insulation capability. This can be carried out in a number of well known ways, such as for example, utilizing a high thermal resistant material, such as thermal resistant plastic with a thicker wall construction of at least 0.25 inches. Other strategies would employ double wall construction and sleeves that could be positioned on the outside of reservoir 12 which could be made of commonly known insulative materials such as foam-like material, paper, cardboard or the like. In certain embodiments of container 10 that will be described herein, it would be ideal to employ insulation positioned strategically so as not to obstruct a user's view of enclosure 14.

Container 10 includes cap 16 which is threaded and upper portion 18 of container 10 comprises neck 19 which is also threaded with compatible threads to those of cap 16. These compatible threads of cap 16 and neck 19 allow the user to easily remove and secure cap 16 to cover upper opening 21, which is defined by neck 19. Opening 21 through which the user in this embodiment drinks the contents of this container 10. In other embodiments, the user can otherwise dispense the liquid contained by container 10 such as pouring the liquid. Exemplary dimensions of upper opening 21 is in the range from 0.75 to 1.5 inches in diameter. This range of size of opening appeals to ease in drinking liquids and avoiding unnecessary spilling of the fluid being consumed during the drinking process. However, other dimensions may be employed.

Exemplary upper portion 18 is illustrated in this embodiment to take on a generally dome configuration and shape, however other shapes are contemplated. In a lower section 23 of upper portion 18 threads are defined by upper portion 18. Lower portion or reservoir 12 of container 10 define threads compatible to the threads defined in upper portion 18. These compatible threads permit upper and lower portions 18 and 12 to be secured together and to separate from one another when desired. In this embodiment, the threads of the cap 16 and the neck 19, as well as, upper portion 18 and lower portion 12 are oriented to be operating in the same direction of rotation for joining the parts and the same direction of rotation for separating the parts. As will discussed below, gaskets or o-rings will be provided proximate to these threaded connection junctures to provide water tight seals and provide resistant torque so as to resist accidental unscrewing of one part from another. In other embodiments, threads can be configured such that cap 16 is removed from upper portion 18 by rotation in a direction and upper portion 18 is removed from lower portion 12 by rotation in an opposite direction. This configuration of threads for securing cap 16 to upper portion 18 and the threads for securing upper portion 18 to lower portion 12 allows someone to hold lower portion 12 with one hand and unscrew cap 16 with the other hand and not loosen upper portion 18 from lower portion 12.

Enclosure 14, in this embodiment, extends from bottom 20 of reservoir 12 of container 10 and is constructed to have at least a portion of enclosure 14 to be hollow or to define space 26. In this illustration, the entire enclosure 14 is constructed of a transparent material to easily view contents or items inserted into the hollow portion or space 26 of enclosure 14. Enclosure 14 is contemplated to have at least a portion of its structure comprise transparent or translucent material in order for a user to be able to view contents positioned within space 26 of enclosure 14. The contents of enclosure 14 which is visible through the transparent material used in constructing enclosure 14 in this illustrated embodiment, will be readily viewed through the transparent material, which also constructs in this embodiment the lower portion or reservoir 12 of container 10. This illustration shows enclosure 14 and lower portion 12 being both constructed of transparent material to be described later herein. It is contemplated that enclosure 14 can be positioned in other positions within the interior of container 10. Enclosure 14 as illustrated is positioned in lower portion or reservoir 12, however enclosure 14 may be positioned in upper portion 18 or enclosure 14 may extend from between both upper and lower portions 18,12. Regardless, of the position or orientation of enclosure 14 within the interior of container 10 it would be contemplated in an embodiment that some portion of enclosure 14 and some portion of either or both upper and lower portion 18, 12 will be constructed of at least one of transparent and translucent material in order for a user to be able to see or view insert item(s) positioned in enclosure 14 from outside of container 10.

The hollow interior portion of enclosure 14, in this illustration, is accessible through an opening 30 shown, in this embodiment, in later figures more clearly in bottom 20 of container 10. Should enclosure 14 be positioned, for example, in upper portion 18, an opening to access the interior hollow portion or space 26 of enclosure 14 could be positioned in upper portion 18 of container 10. A plug member 22, in this illustration is used to seal closed opening 30 that accesses the interior of enclosure 14. As will be described in more detail herein plug member 22 can be removed to access and remove insert items from interior 26 of enclosure 14 and to position other different insert items for display into interior 26 of enclosure 14. As will be discussed in more detail, plug member will be used to provide a water tight seal between the outside of container 10 and the interior of enclosure 14.

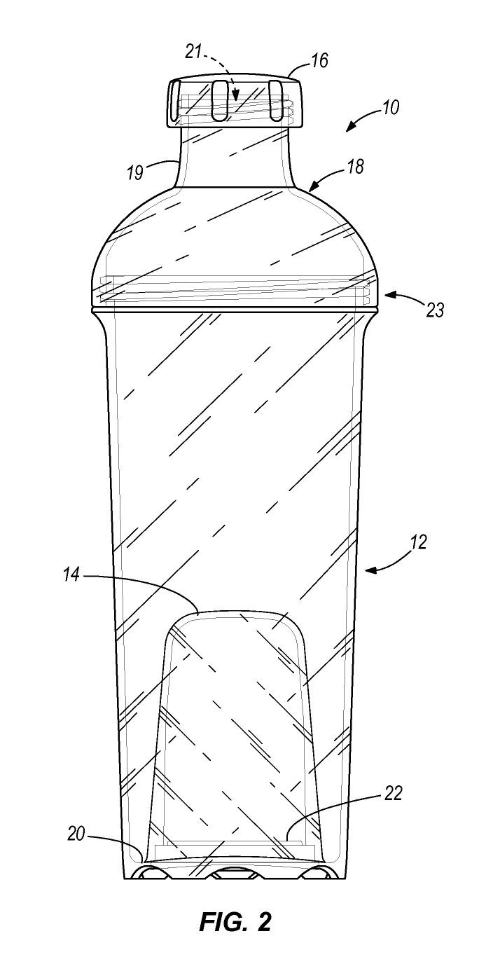

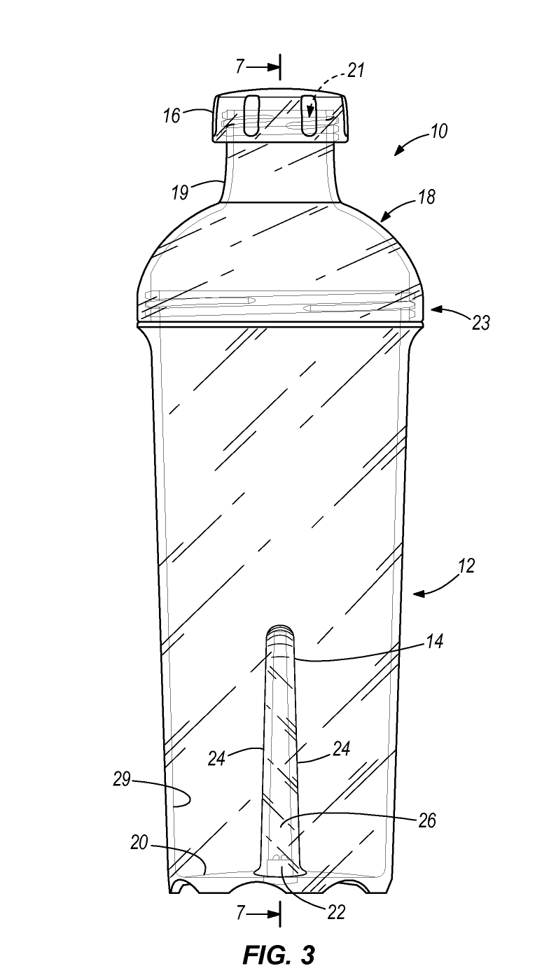

In referring to FIG. 2, container 10 is assembled with container 10 oriented showing a front profile of enclosure 14 which is wider in dimension than side profile of enclosure 14 as shown in FIG. 3. In this orientation, with enclosure 14 constructed of a transparent and/or translucent material, more of what is contained in space 26 of enclosure 14 can be viewed from outside of container 10. In this example, and as will be further described herein, enclosure 14 externally takes a shape of a fin or paddle. This shape will add to turbulence to liquid positioned in bottle 10 when bottle 10 is shook thereby facilitating mixing of ingredients contained in the liquid in container 10. In this embodiment, it can be seen, in FIG. 2, the width dimension of the enclosure 14 reduces in size as enclosure 14 extends from bottom 20.

In referring to FIG. 3, container 10 is assembled with container 10 oriented showing a narrower profile of enclosure 14. This a side profile of enclosure 14 showing in this embodiment the enclosure has a smaller dimension in the side profile than in the front profile as shown in FIG. 2. In this illustrated embodiment, opposing spaced apart wall members 24 contribute to forming the hollow interior or space 26 within enclosure 14. Opposing spaced apart wall members 24 in this embodiment are generally planar in construction and thereby provide opposing viewing panels for enclosure 24. These generally planar viewing panels, as seen in this embodiment, accommodate and display cards or sheets as insert items that carry information to be displayed from within enclosure 14 and be seen by an observer from outside of container 10. In this embodiment, the insert can be easily viewed through either opposing spaced apart wall members 24. These opposing panels provide a wide range of viewing angles for the insert. The shape of enclosure 14 and the shape and configuration of space 26 defined by enclosure 14 can be made as desired. Space 26 can be dimensioned and shaped to accommodate the desired insert item(s) that will be positioned within that space for display through spaced apart wall members 24 as illustrated in this embodiment. In this embodiment, lower portion 12 and enclosure 14 are injected molded in one piece. Other construction methods may be employed.

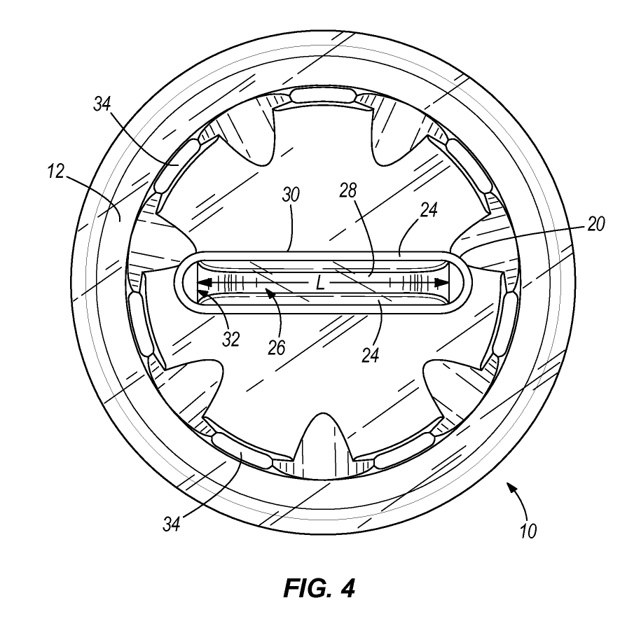

In referring to FIG. 4, container 10 is being viewed from the bottom of container 10 wherein plug member 22 is removed from bottom opening 30. Bottom opening 30 is defined in a bottom wall 20 of container 10. A clear view of the interior or space 26 of enclosure 14 can be seen and is in communication with opening 30. As can be seen in FIG. 4, the dimension or distance between opposing spaced apart wall members 24 is less than the dimension 90 degrees from that dimension or as in the this instance the dimension of the length L of space 26 proximate to opening 30. Spaced apart opposing wall members 24 of enclosure 14 are joined at their highest ends of this embodiment by upper transition wall portion 28 and along their sides, as seen in FIG. 1 with side transition wall portion 32. This construction maintains interior 26 of enclosure 24 separate from the interior of reservoir 12 and container 10, Thus, items for display that are positioned within interior 26 will not come into contact with fluid contents of container 10. In this embodiment, legs 34 are provided to provide spacing of bottom wall 20 of bottle 10 from a support surface upon which container 10 is set upon.

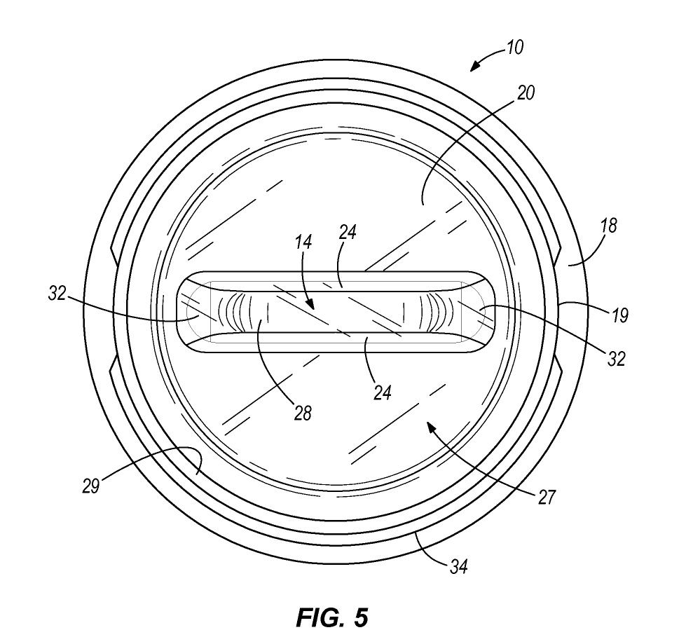

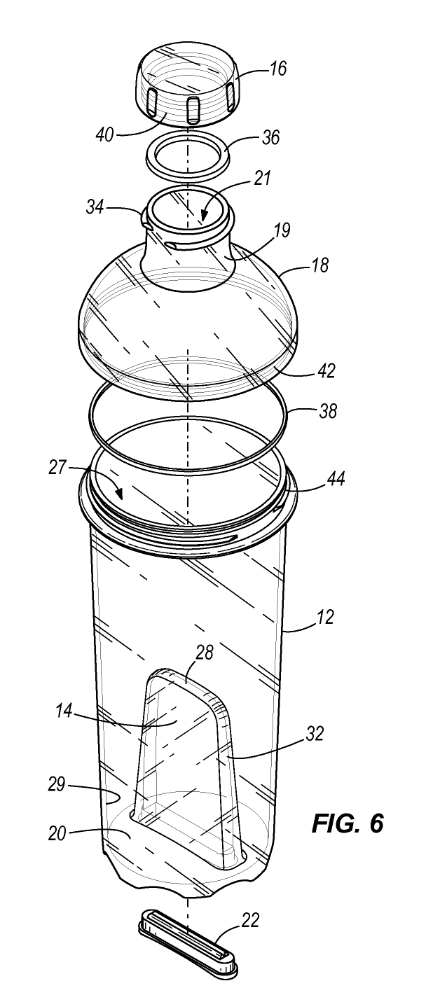

In referring to FIG. 5, container 10 is viewed from the top of reservoir 12 viewing into the interior of container 10 through top opening 27 defined by sidewall 29, as seen in FIG. 6, and seeing enclosure 14. As illustrated in this embodiment, spaced apart opposing side wall members 24, upper transition wall portion 28 and side transition wall portion 32 form enclosure 14 can be seen. As can be seen in FIG. 5 and in FIG. 6 opening 27 of reservoir 12 is of equal or greater dimension than bottom 20. This dimensional relationship facilitates the cleaning of reservoir 12 by hand or by use of a dishwasher. Moreover, opening 27 is of greater dimension than opening 21 of neck 19 and this greater dimension provides ease in inserting items such as fluid, pieces of food, powder, syrup and/or ice into reservoir 12. Thus, opening 27 allows ease in assembling the ingredients of a drink into reservoir 12 and to clean reservoir 12 once the user needs to clean the same.

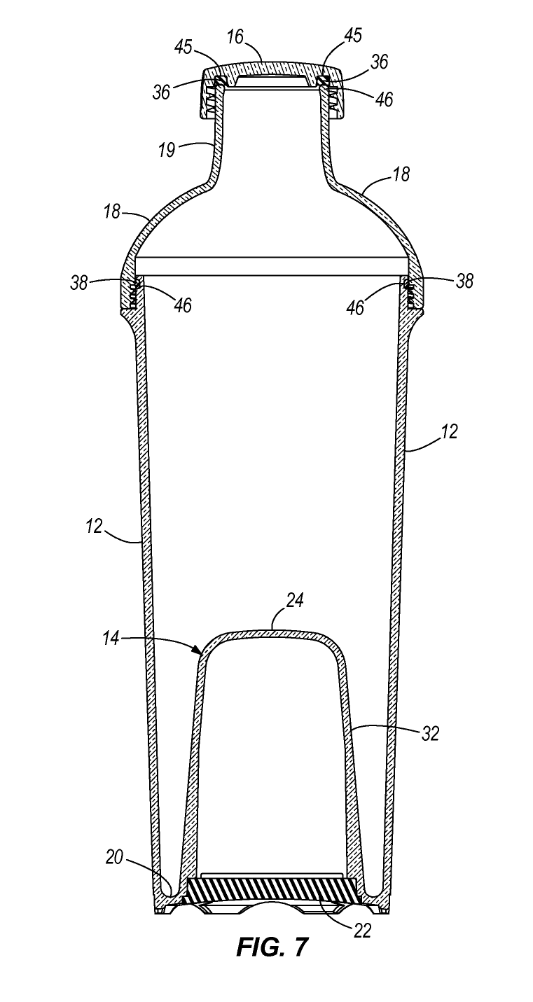

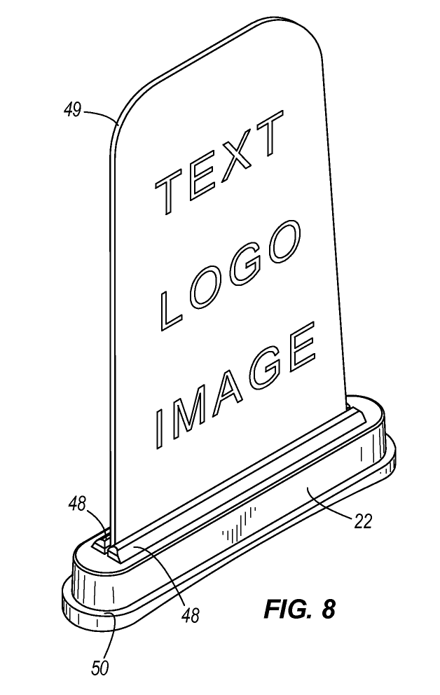

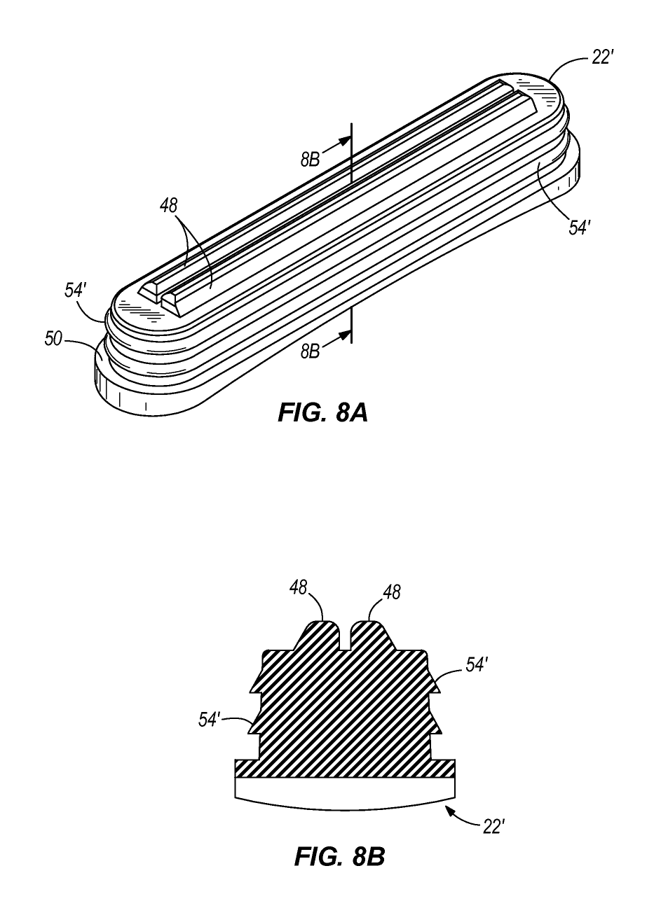

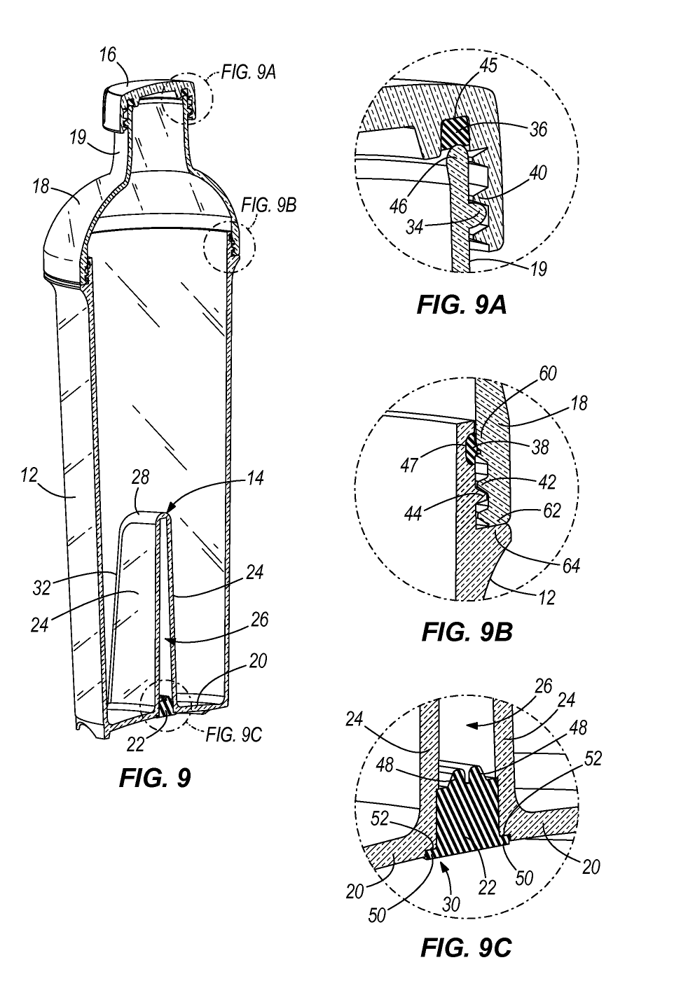

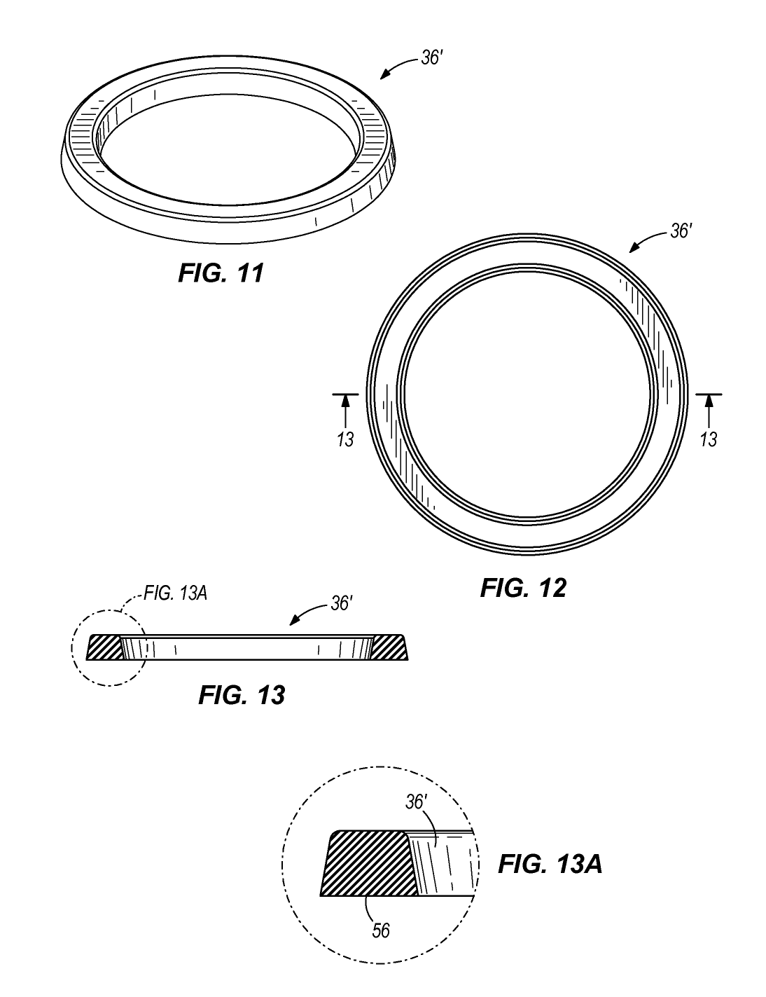

In referring to FIG. 6, container 10 is seen in an exploded view wherein cap seal 36, bottle seal 38 and plug member 22 are seen and will be discussed in further detail herein below and shown in FIGS. 7-9A-C and FIGS. 11-16. Threads 40 positioned in the interior of cap 16, as seen in FIG. 6 and FIG. 9A, are compatible with threads 34 positioned on neck 19, likewise seen in FIG. 6 and FIG. 9A. In this embodiment, the configuration of the threads 34 and 40 permit the user to release or secure cap 16 in less than a full rotation of cap 16 relative to the remainder of container 10. As seen in FIG. 7 and FIG. 9A, cap 16 and neck 19 are engaged with cap seal 36 positioned trapped between cap 16 and a top portion 46 of neck 19. Cap seal 36 is positioned in an annular groove 45 positioned in cap 16. The positioning of cap seal 36 provides very little contact with fluid within bottle 10 and makes it easy to clean. Cap seal 36 in this illustration is made of FDA grade silicone sized as AS-213. Other commonly known gaskets or o-rings are contemplated to be employed in other embodiments. Seal 36 in combination with threads 34 and 40 provide a water tight seal with cap 16 engaged with neck 19.

Another embodiment of cap seal 36, is shown in FIGS. 11-13A. Cap seal 36′, is constructed of FDA contact approved grade silicone as mentioned above. In this embodiment, cap seal 36′ is sized and shaped to fit in contact with all sides of annular groove 45, as seen in FIG. 9A, and thereby create no gaps with annular groove 45 wherein food or fluid could be trapped or collect. This configuration maintains a cleaner bottle and is easier to clean. Side 56 as seen in FIG. 13A is substantially flat for receiving top portion 46 of neck 19 of container 10 as seen in FIG. 9A forming a water tight seal. This flat surface will create less resistant torque with top portion 46 of neck 19 than body seal 38 does with body portion of upper portion 18 as seen in FIG. 9A, which will be discussed in more detail below.

Similarly, container seal 38, as seen in FIGS. 6, 7 and 9B, is positioned between upper portion 18 and lower portion 12 with the two portions threadingly engaged. Threads 42 are defined in upper portion 18 and threads 44 are defined in lower portion 12 wherein both are compatible with one another. With both sets of threads 42 and 44 engaged, as seen in FIG. 7 and FIG. 9B, container seal 38 is trapped between upper and lower portions 18, 12. Container seal 38, in this embodiment, is positioned within an annular groove 47 positioned about the outside of lower portion 18 in this embodiment. With container seal 38 in this position it does not come into contact with fluid contained within container 10. Container 10 seal 38 stays cleaner longer and is easy to clean. In this illustration, bottle seal 38 is constructed of FDA grade silicone sized AS 039. Other commonly known gaskets or o-rings are contemplated to be employed in other embodiments. Seal 38 in combination of threads 42 and 44 provide a water tight seal with upper portion 18 and lower portion 12 engaged.

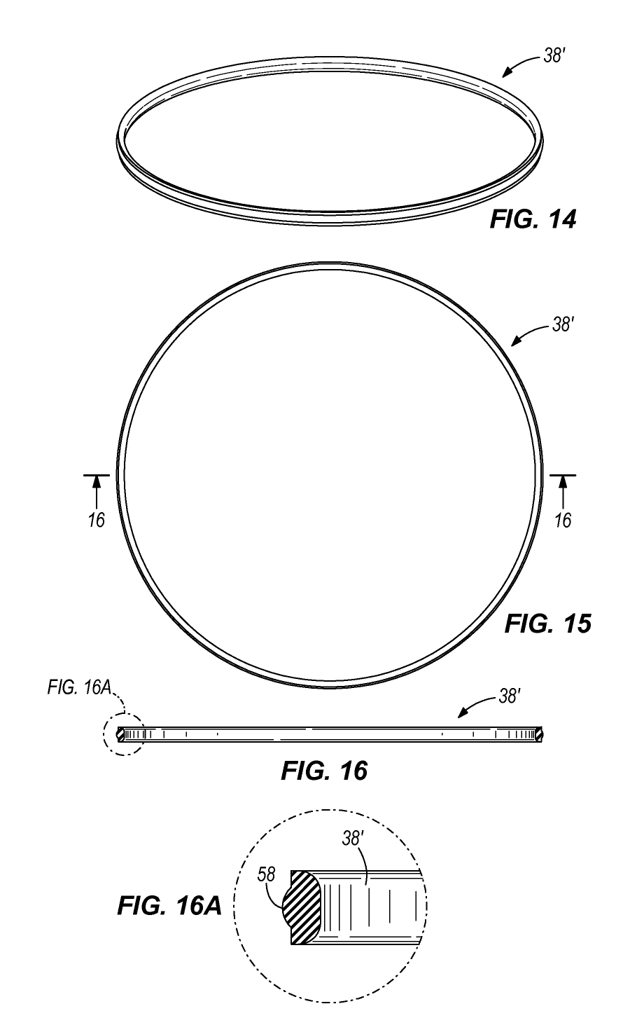

Another embodiment of seal 38 is shown as 38′ in FIGS. 14-16A. Body seal 38′, is constructed of FDA contact approved grade silicone as mentioned above. In this embodiment, body seal 38′ is sized and shaped to fit in contact with all sides of annular groove 47, as seen in FIG. B. With this configuration, there are no gaps created with annular groove 47 wherein food or fluid could be trapped or collect. This configuration maintains a cleaner bottle and is easier to clean. Side 58 as seen in FIG. 16A has a slight bulge configuration. This is in contrast to cap seal 36′ described above which has a flat engaging side. Side 58 serves several purposes in this embodiment. With the bulging configuration side 58 provides an interference fit with a cylindrical portion of upper portion 18 as seen in FIG. 9B. Also, side 58 is larger and generally longer for creating more friction with upper portion 18 than cap seal 36′ does with upper portion 46 of neck 19 as seen in FIG. 9A. The interference fit and larger generation of friction caused by the configuration of body seal 38′ in contrast to cap seal 36′, causes greater resistant torque for opening bottle 10 between upper and lower portions 18,12 than the resistant torque created by cap seal 36′ for opening cap 16 from neck 19. This increased resistant torque between the upper portion and lower portion 18,12 prevents the two portions 18,12 from loosening during repeated openings and closings of cap 16 with neck 19. Additionally, in the process of closing container 10, bottom 62 of upper portion 18, as seen in FIG. 9B, contacts upper surface 64 of lower portion 12 giving the user a visual indication container 10 is closed in a water tight fashion. However, should the user inadvertently leave a small gap between bottom 62 and upper surface 64, the positioning of body seal 38′ and its configuration in engaging a cylindrical portion of upper portion 18 continues to provide a water tight seal between upper and lower portions 18,12 even when upper portion 18 is not completely threadingly engaged with lower portion 12.

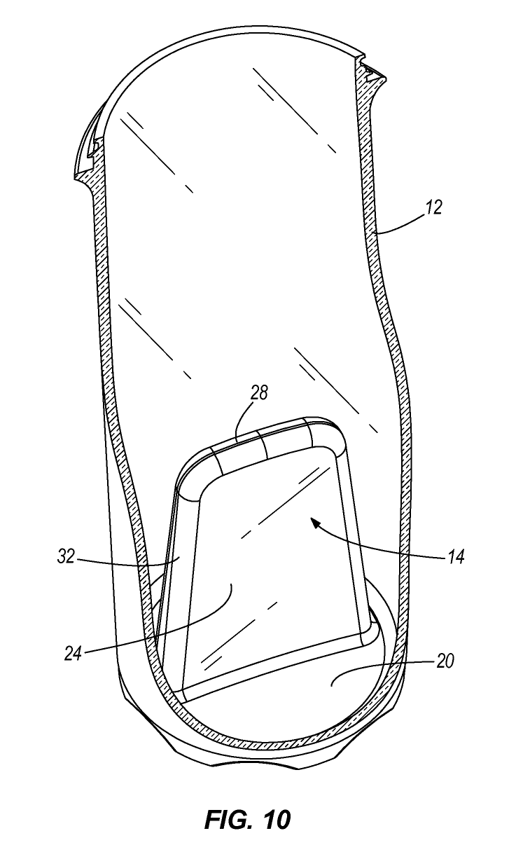

In referring to FIG. 8, plug member 22 is shown which is used to close opening 30 in the bottom of bottle 10 and create a water tight fit. Plug member in this embodiment is constructed of TPE (Thermoplastic Elastomer) and is sized to create a snug fit with the perimeter of bottom opening 30 as seen in FIG. 9C. Plug 22 releasably secures to bottom 20 which permits plug 22 to be positioned within opening 30 and to be removed from the same. Two parallel and spaced apart tabs 48 extend along the top of plug 22. This configuration of tabs 48 can be employed to support and frictionally grasp an insert item, such as card 49, that would be displayed from within enclosure 14. With insert item grasped by tabs 48, the insert item could be readily removed with removing plug member 22. Shoulder 50 is provided in this embodiment and is received by recess 52, as seen in FIG. 9C to contribute to the water tight fit and prevent over insertion. Plug 22 with its snug interference fit with the perimeter of bottom opening 30 allows one to wash container 10 by hand or by way of dishwasher and maintain interior 26 of enclosure 14 dry. Sidewalls 54 of plug member 22 can take on a smooth tight fit with the perimeter of opening 30 and in other embodiments the sidewalls can define rib members 54′ as seen in FIG. 8A and 8B. The fit of plug member 22 with the perimeter of opening 30 is to accomplish a water tight fit and prevent water from entering interior 26 of enclosure 14 as seen in FIG. 9C. In referring to FIG. 10, a broken away view of reservoir 12 is shown with enclosure 14 positioned in the interior of container 10 extending from bottom wall 20.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention. It is intended that the scope of the invention not be limited by the specification but be defined by the claims set forth below.

1. A fluid dispensing device, comprising:
a reservoir comprising a sidewall and a bottom wherein the sidewall defines an opening to the reservoir opposing the bottom wherein the opening is one of equal or greater dimension than the bottom; and
an enclosure positioned within the reservoir wherein the enclosure defines a space separate from an interior of the reservoir wherein the space is in communication with another opening defined by one of the bottom and the sidewall for accessing the space from an exterior of the reservoir.

2. The dispensing device of claim 1 wherein at least a portion of the reservoir is constructed of one of a transparent and translucent material.

3. The dispensing device of claim 2 wherein the reservoir is constructed entirely of one of a transparent material and translucent material.

4. The dispensing device of claim 1 wherein the reservoir is constructed of a plastic material.

5. The dispensing device of claim 4 wherein the reservoir is constructed of a thermal plastic material.

6. The dispensing device of claim 1 wherein the sidewall defines the shape of the opening to be generally circular.

7. The dispensing device of claim 6 wherein the sidewall adjacent the opening defines threads

8. The dispensing device of claim 7 includes a top portion dimensioned to cover the opening wherein the top portion defines threads compatibly shaped to the threads defined by the sidewall to threadingly secure the top portion to the reservoir.

9. The dispensing device of claim 8 an O-ring positioned between the top portion and the reservoir providing a water tight seal between the top portion and the reservoir with the threads of the top portion threadingly engaged to the threads of the reservoir.

10. The dispensing device of claim 6 wherein the top portion comprises a neck and wherein the neck defines an opening.

11. The dispensing device of claim 10 wherein the neck defines threads.

12. The dispensing device of claim 11 includes a cap defining threads compatibly shaped to engage the threads defined by the neck.

13. The dispensing device of claim 1 wherein the enclosure comprises two spaced apart wall members.

14. The dispensing device of claim 13 wherein each of the two spaced apart wall members are constructed to be generally planar.

15. The dispensing device of claim 14 wherein the dimension of the space defined by the enclosure has a smaller dimension between the two spaced apart wall members than a dimension of the space defined by the enclosure 90 degrees to the dimension between the spaced apart wall members.

16. The dispensing device of claim 13 wherein at least a portion of one of the two spaced apart wall members is constructed of one of a transparent and translucent material.

17. The dispensing device of claim 16 wherein the two spaced apart wall members are constructed of one or a transparent and translucent material.

18. The dispensing device of claim 13 wherein the two spaced apart wall members are interconnected with another wall forming a water tight barrier between the space defined by the enclosure and an interior of the reservoir.

19. The dispensing device of claim 1 wherein the enclosure has a greater width dimension in a front profile than a width dimension in a side profile.

20. The dispensing device of claim 19 the width dimension of the enclosure in the front profile reduces in dimension as the enclosure extends away from one of the bottom and sidewall of the reservoir.

21. The dispensing device of claim 1 includes a removable plug dimensioned to close the other opening.

22. A method for assembling a fluid dispensing device, comprising the steps of:
providing a reservoir comprising a sidewall and a bottom wherein the sidewall defines an opening opposing the bottom wherein the opening is one of equal or greater dimension than the bottom and an enclosure positioned within the reservoir wherein the enclosure defines a space separate from an interior of the reservoir wherein the space is in communication with another opening defined by one of the bottom and the sidewall for accessing the space from an exterior of the reservoir;
placing an insert item which carries visual information into the space defined by the enclosure,

23. The method for assembling a fluid dispensing device of claim 22 including the step of positioning a plug in the other opening enclosing insert item in the space.

24. The method for assembling a fluid dispensing device of claim 23 including the step of removing the plug then removing the insert item from the space and inserting an insert item carrying different visual information than the display information carried by the insert item that was removed.

25. The method for assembling a fluid dispensing device of claim 22 including the step of securing a top portion to the reservoir wherein the top portion defines a neck which defines an opening.

26. The method for assembling a fluid dispensing device of claim 25 including the step of unsecuring the top portion from the reservoir and placing at least one of a fluid, powder, ice, solid food item and another fluid into the reservoir.

27. The method for assembling a fluid dispensing device of claim 25 including the step of unsecuring the top portion from the reservoir and placing both the top portion and the reservoir into a dishwasher.

28. The method for assembling a fluid dispensing device of claim 25 including the step of securing a cap to the neck closing the opening defined by the neck.

29. A fluid dispensing device, comprising:
a reservoir comprising a sidewall and a bottom; and
an enclosure positioned within the reservoir wherein the enclosure defines a space separate from an interior of the reservoir wherein the space is in communication with another opening defined by one of the bottom and the sidewall for accessing the space from an exterior of the reservoir and wherein the enclosure comprises opposing spaced apart wall members.

30. The dispensing device of claim 28 wherein at least a portion of the reservoir is constructed of one of a transparent and translucent material.

31. The dispensing device of claim 30 wherein the reservoir is constructed entirely of one of a transparent material and translucent material.

32. The dispensing device of claim 29 wherein the reservoir is constructed of a plastic material.

33. The dispensing device of claim 32 wherein the reservoir is constructed of a thermal plastic material.

34. The dispensing device of claim 29 wherein the sidewall defines an opening opposing the bottom.

35. The dispensing device of claim 34 wherein the opening is generally circular in shape.

36. The dispensing device of claim 34 wherein the sidewall adjacent the opening defines threads

37. The dispensing device of claim 34 includes a top portion dimensioned to cover the opening wherein the top portion defines threads compatibly shaped to the threads defined by the sidewall to threadingly secure the top portion to the reservoir.

38. The dispensing device of claim 37 an O-ring positioned between the top portion and the reservoir providing a water tight seal between the top portion and the reservoir with the threads of the top portion threadingly engaged to the threads of the reservoir.

39. The dispensing device of claim 37 wherein the top portion comprises a neck and wherein the neck defines an opening.

40. The dispensing device of claim 39 wherein the neck defines threads.

41. The dispensing device of claim 40 includes a cap defining threads compatibly shaped to engage the threads defined by the neck.

42. The dispensing device of claim 29 wherein each of the two spaced apart wall members are constructed to be generally planar.

43. The dispensing device of claim 42 wherein the dimension of the space defined by the enclosure has a smaller dimension between the two spaced apart wall members than a dimension of the space defined by the enclosure 90 degrees to the dimension between the spaced apart wall members.

44. The dispensing device of claim 29 wherein at least a portion of one of the two spaced apart wall members is constructed of one of a transparent and translucent material.

45. The dispensing device of claim 44 wherein the two spaced apart wall members are constructed of one or a transparent and translucent material.

46. The dispensing device of claim 29 wherein the two spaced apart wall members are interconnected with another wall forming a water tight barrier between the space defined by the enclosure and an interior of the reservoir.

47. The dispensing device of claim 29 wherein the enclosure has a greater width dimension in a front profile than a width dimension in a side profile.

48. The dispensing device of claim 47 the width dimension of the enclosure in the front profile reduces in dimension as the enclosure extends away from one of the bottom and sidewall of the reservoir.

49. The dispensing device of claim 29 includes a plug dimensioned to releasably close said other opening.

50. A method for assembling a fluid dispensing device, comprising the steps of:
providing a reservoir comprising a sidewall and a bottom and an enclosure positioned within the reservoir wherein the enclosure defines a space separate from an interior of the reservoir wherein the space is in communication with another opening defined by one of the bottom and he sidewall for accessing the space from an exterior of the reservoir;
placing an insert item which carries visual information into the space defined by the enclosure.

51. The method for assembling a fluid dispensing device of claim 50 including the step of positioning a plug in the other opening enclosing insert item in the space.

52. The method for assembling a fluid dispensing device of claim 51 including the step of removing the plug then removing the insert item from the space and inserting an insert item carrying different visual information than the display information carried by the insert item that was removed.

53. The method for assembling a fluid dispensing device of claim 50 including the step of securing a top portion to the reservoir wherein the top portion defines a neck which defines an opening.

54. The method for assembling a fluid dispensing device of claim 53 including the step of unsecuring the top portion from the reservoir and placing at least one of a fluid, powder, ice, solid food item and another fluid into the reservoir.

55. The method for assembling a fluid dispensing device of claim 53 including the step of unsecuring the top portion from the reservoir and placing both the top portion and the reservoir into a dishwasher.

56. The method for assembling a fluid dispensing device of claim 53 including the step of securing a cap to the neck closing the opening defined by the neck.
